(19) United States
(12) Patent Application Publication
(10) Pub. No.: US 2019/0152537 A1
(43) Pub. Date: May 23, 2019

(54) INTEGRATION OF SMART COMPOSITE MICROSTRUCTURES (SCM) AND RIGID CHASSIS

(71) Applicant: Dash Robotics, Inc., Hayward, CA (US)

(72) Inventors: Andrew George GILLIES, Oakland, CA (US); Dwight SPRINGTHORPE, II, Albany, CA (US); Quillon TSANG, Daly City, CA (US); Nicholas Joseph KOHUT, Mountain View, CA (US)

(21) Appl. No.: 16/195,193

(22) Filed: Nov. 19, 2018

Related U.S. Application Data
(60) Provisional application No. 62/588,854, filed on Nov. 20, 2017.

(51) Int. Cl. B62D 29/00; B62D 29/04; B62D 29/02; B62D 27/02; B62D 27/06; B62D 65/02; A63H 29/22; B32B 3/14

(52) U.S. Cl. CPC B62D 29/00; B62D 29/043; B62D 29/02; B62D 29/008; G05D 1/021; B62D 27/065; B62D 65/02; A63H 29/22; B32B 3/14; B62D 27/02

(57) ABSTRACT

A robot with flexible mechanics and locomotive capability is described herein. According to certain embodiments, the robot has at least one Smart Composite Microstructure (SCM) component with flexible mechanics, a rigid module that is attached to the at least one SCM component, and at least one internal component that provides locomotive capabilities to the robot. In some embodiments, a unique assembly process of the robot is described. In some embodiments, the unique assembly process employs a combination of label indicators, orientation indicators, and connection patterns to ensure an easy and reliable assembly process.

### RELATED APPLICATIONS

This application claims the benefit of U.S. Provisional Patent Application No. 62/588,854, titled “INTEGRATION OF SMART COMPOSITE MICROSTRUCTURES (SCM) AND RIGID CHASSIS,” which was filed on Nov. 20, 2017. This application is also related to U.S. patent application Ser. No. 14/679,143, titled “COMPOSITE MICROSTRUCTURES,” which was filed on Apr. 6, 2015. Both references are incorporated by reference herein their entirety.

### TECHNICAL FIELD

The subject matter disclosed in this application generally relates to robots, and more specifically, to robotic toys, such as a biomimetic children's toy, remote-controlled toy, crawler robot, autonomous robot, or any other suitable robot or combination of robots.

### BACKGROUND

Smart Composite Microstructure (SCM) technology is a manufacturing process that was originally developed at UC Berkeley for the construction of robots at the millimeter scale. This technique can generate robot components (SCM components) for fast assembly. The process starts with combining two rigid layers and a flexible layer in a laminate structure to form a sheet. The flexible layer, which is frictionless, scales well to small structures. Once the flexible layers are sandwiched between the rigid layers, the sheet is generally carved using a laser cutter to expose the flexible layer. The end product is a flat structure with lines of exposed flexible layer. The flat structure is then folded into a final three-dimensional shape to create a useful device.

SCM components by themselves are not ideal for making robotic toys for children. Robots made entirely out of SCM components are too fragile. For instance, a SCM chassis is likely to break into pieces upon falling to the ground, thus causing damage to the enclosed electronics. In some instances, it may be too expensive to make a robot chassis entirely out of SCM components. As for assembly, tiny tools such as tweezers are usually required for building a robot with SCM components. This is not ideal for robot toys. Robotic toys for children should be easily constructible by hand without the need for sharp tools. Therefore, to make the SCM technology suitable for robotic toys, a new design is needed.

### SUMMARY

In some embodiments, a robot with flexible mechanics and locomotive capability is provided. The robot has at least one Smart Composite Microstructure (SCM) component with flexible mechanics, a rigid module connected to the at least one SCM component, and at least one internal component that provides locomotive capabilities to the robot.

In some embodiments, the SCM components are composed of two rigid layers with a flexible layer sandwiched in between. In some embodiments, the SCM components have a first flat structural region with an integral flexible layer sandwiched between two rigid layers, a second flat structural region with the integral flexible layer sandwiched between another two rigid layers, and a bendable joint region connecting the first and second flat structural regions composed of just the integral flexible layer. In some embodiments, the integral flexible layer is made of a bendable material. In some embodiments, the bendable material is flexible and has a tear resistance greater than 10 N.

In some embodiments, the robot is a toy robot, biomimetic toy, remote-controlled robot, crawler robot, autonomous robot, or any other suitable robot or combination of robots. In some embodiments, the rigid module functions as a rigid spine of the robot. In some embodiments, the rigid module functions as a chassis for the robot. In some embodiments, the rigid module provides at least one connecting terminal for a SCM component. In some embodiments, the internal component is a motor with at least one motor output. According to some embodiments, at least one SCM component is connected to the motor output such that the internal component could cause the robot to move by actuating the connected SCM component.

In some embodiments, an assembly system with one or more assembly indicators is provided. In some embodiments, the assembly system requires multiple assembly indicators to work together to ensure an error-free assembly process. In some embodiments, the SCM components and the rigid module employ unique indentation and protrusion patterns to reduce the chance of misconnections. In some embodiments, the SCM components and the rigid module employ a marking system to highlight the correct connection terminal.

### BRIEF DESCRIPTION OF DRAWINGS

Various objects, features, and advantages of the disclosed subject matter can be more fully appreciated with reference to the following detailed description of the disclosed subject matter when considered in connection with the following drawings, in which like reference numerals identify like elements. While multiple embodiments are disclosed, still other embodiments of the present disclosure will become apparent to those skilled in the art from the following detailed description, which shows and describes illustrative embodiments of the disclosure. Accordingly, the drawings and detailed descriptions are to be regarded as illustrative in nature and not restrictive. Many of the figures presented herein are black and white representations of images originally created in color.

FIG. 1 illustrates a cross sectional view of a SCM component according to certain embodiments.

FIG. 2 illustrates a flat SCM component with flexible layers exposed according to certain embodiments.

FIG. 3 illustrates a folded SCM component according to certain embodiments.

FIG. 4 illustrates some building blocks of a robot including flat SCM components on a single sheet, rivets, and a rigid module according to certain embodiments.

FIG. 5 illustrates flat SCM components removed from a SCM component sheet according to certain embodiments.

FIG. 6 illustrates a robot toy resembling a crawling insect according to certain embodiments.

FIG. 7 illustrates attachment of two SCM components to the rigid module according to certain embodiments.

FIG. 8 illustrates how rivets secure the SCM components to a rigid module according to certain embodiments.

FIG. 9 illustrates using matching letters and complementary slot shapes to facilitate the assembly according to certain embodiments.

FIG. 10 illustrates using letter matching to avoid misconnecting mirroring SCM components according to certain embodiments.

FIG. 11 illustrates an upside-down view of a robot with all SCM components connected according to certain embodiments.

FIG. 12 illustrates using unique connecting interfaces to ensure proper connections of two or more similar SCM components according to certain embodiments.

FIG. 13 illustrates connecting a SCM component to a motor output connection by snapping on the SCM component according to certain embodiments.

FIG. 14 illustrates an exemplary process for assembling a robot according to certain embodiments.

### DETAILED DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

The following description makes reference to spatial relations in addition to directional orientations, such as views with regard to the figures. However, any terms such as up, down, left, right, top, bottom, front, back, above, below, upper, lower, proximal, distal, and the like are used primarily to differentiate between the views and orientations relative to other building elements or pieces within any particular configuration, or series of views or illustrations, and to help describe the relationship between pieces to the reader.

The invention presented here describes a three-dimensional (3D) robot with flexible mechanics and locomotive capability. In some embodiments, the robot is designed as a toy robot. In some embodiments, the robot is configured to simulate the appearance and movement of an insect. In some embodiments, the robot has shock-absorbing feet made out of SCM components and a hard-shell body to protect the electronics inside. The shock-absorbing feet are designed to allow the robot to travel over a surface swiftly. The hard-shell body is designed with connector terminals to allow SCM components to attach. The hard-shell body can take on the appearance of different species of insects such as ladybugs, scorpions, beetles, grasshoppers, or any other suitable insects. In some embodiments, the hard-shell body can take on the appearance of any other suitable objects such as cars, dinosaurs, or other animals.

The present disclosure also includes a unique assembly system designed to help assemblers with no robot building experience to construct the robot in an efficient manner. According to certain embodiments, the SCM components are printed on a SCM sheet with incision lines to facilitate easy detachment. Fabricating SCM components on a SCM sheet is not only cost effective but also ensures that all the components are produced for assembly. According to certain embodiments, the SCM components are labeled with various assembly indicators. These indicators are designed to assist the builders in connecting parts of similar shapes and sizes to the right location.

According to certain embodiments, the 3D robot is composed of one or more Smart Composite Microstructure (SCM) components with flexible mechanics, a rigid module connected with at least one of the one or more SCM components, and at least one internal component sandwiched between the rigid module and SCM components. The at least one internal component is configured to mobilize the robot. In some embodiments, the SCM components described here are the same SCM component disclosed in U.S. patent application Ser. No. 14/679,143, titled “COMPOSITE MICROSTRUCTURES,” which is incorporated by reference in its entirety.

### SCM Components

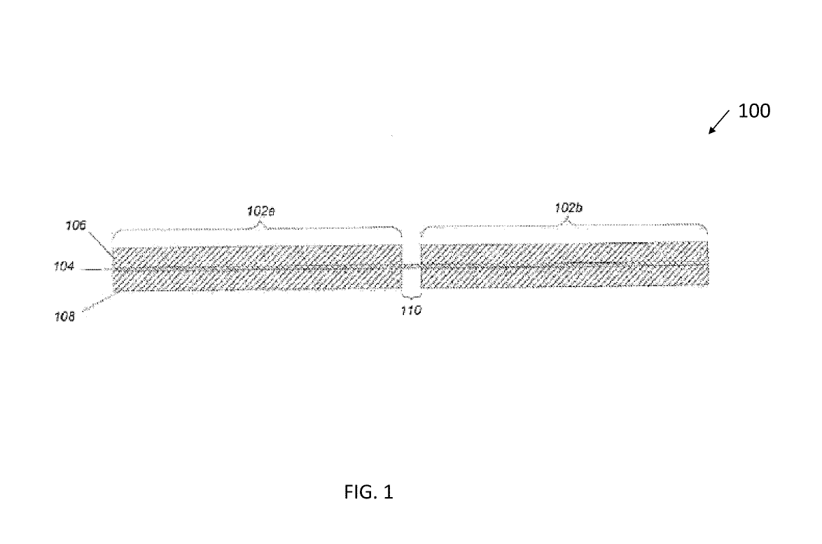

The SCM components described herein are made of multiple structural layers. FIG. 1 illustrates a cross-sectional view of a flat SCM component 100 according to some embodiments. The SCM component has a first flat structural region 102a that includes a first portion of two rigid structural layers 106 and 108 with the first portion of an integral flexible layer 104 sandwiched in between, a second flat structural region 102b with a second portion of two rigid structural layers that sandwiches the second portion of the integral flexible layer 104, and a bendable joint region 110 with the third portion, the integral flexible layer 104. The bendable joint region 100 connects the first flat structural region 102a and the second flat structural region 102b.

In some embodiments, the integral flexible layer 104 is made of a flexible material that can be molded to an effective thickness. According to some embodiments, the effective thickness is between 15 to 150 microns. However, the effective thickness can be any other suitable size or range. The flexible material should provide a proper level of “springiness” in the joint region 110 such that the SCM component can be bent into a 3D configuration and then remain in that shape thereafter. Ideally, the integral flexible layer should not be overly thick. An excessive stiffness in the joints due to an overly thick flexible layer may reduce movement efficiency and require excessive energy output to operate. On the other hand, the integral flexible layer should not be too thin. A thickness below the effective range may be too yielding and not able to hold shape or provide sufficient structural support.

In some embodiments, the integral flexible layer 104 is made of a flexible material with sufficiently high tear strength. In some embodiments, the flexible layer material in the SCM components can withstand upward of 10 N, or any other suitable N value, of force before tearing. A material with a tear resistance above 10 N can generally withstand normal assembly and operation. If the flexible material has a tear resistance significantly below 10 N, the chances of tearing during normal assembly and use rises greatly. In some embodiments, ripstop nylon is used for the integral flexible layer. In some embodiments, ripstop dacron is used for the integral flexible layer. Other suitable materials or combination of materials with similar tear strength can also be used.

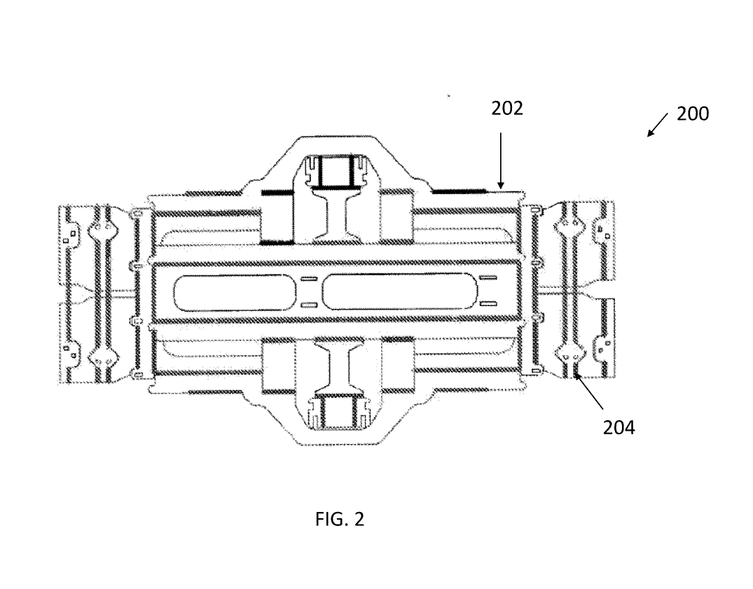

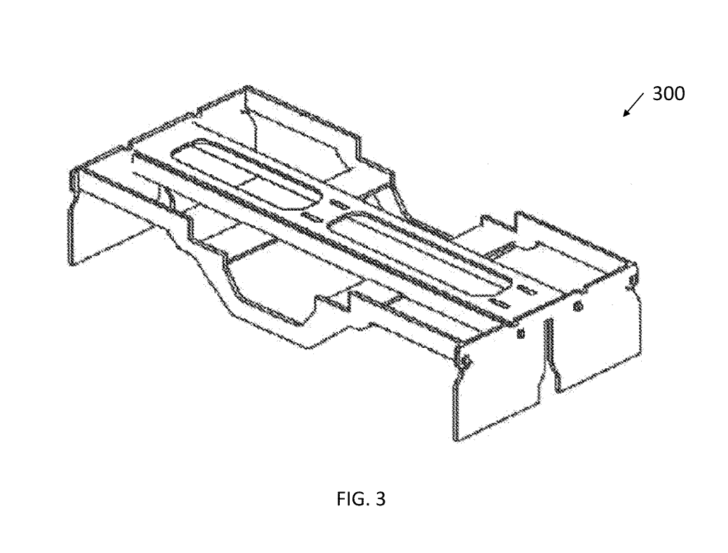

FIG. 2 illustrates a flat SCM component according to certain embodiments. The exposed flexible layer acts as fold lines to facilitate folding the flat SCM component 200 into a 3D structure. The outer edges 202 represent cuts through all three layers in order to form the pattern of the component 200, while the inner edges 204, shown in bold, are made by removing only the rigid layers as described above with respect to FIG. 1. These “flexure cuts” result in joint regions 204 where the flat SCM component 200 can be folded to form faces oriented in different planar directions (e.g., FIG. 3).

FIG. 3 illustrates a 3D robot frame 300 according to certain embodiments. The 3D robot frame is folded from a 2D flat SCM component similar to the one shown in FIG. 2. Once 2D flat SCM components are cut from the sheet, they can be folded and assembled to form a 3D structure. Some structures are formed by bending, while other structures can be made by connecting other components.

### Robot Assembly

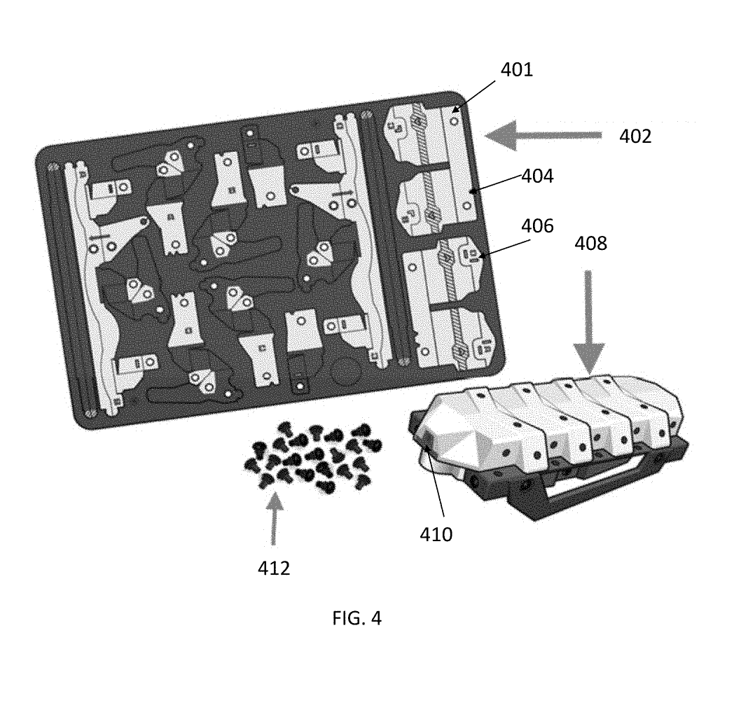

FIG. 4 illustrates the building blocks for a toy robot including flat SCM components on a SCM component sheet 402, a rigid module 408, and rivets 410 according to certain embodiments. The SCM component sheet 402 includes multiple embedded 2D flat SCM components. The SCM component sheet 402 is designed to fit as many SCM assembly components as possible without compromising the integrity of the components. In some embodiments, the assembly indicators such as letters, numbers, and arrows are directly printed on the flat SCM components 401. In some embodiments, insertion terminals 406 and connection patterns 404 are also incorporated. In some embodiments, different the SCM components have different colors and/or pattern.

According to some embodiments, the rigid module 408 is not made by the SCM technology. In some embodiments, the rigid module 408 has a window 410 for housing sensors, recording devices, lights, or other electronic components. In some embodiments there can be multiple windows on multiple sides of the rigid module. In some embodiments, the top side of the rigid module 408 contains connecting hubs for adding other robot features.

Various materials can be used for constructing the rigid module including but not limited to metal, plastic, fortified plastic, fiberglass, wood, aluminum, steel, or any other suitable material or combination of materials. In some embodiments, two or more subparts are connected together to make the rigid module. For example, rigid module 408 has a top component in white, a bottom component in dark gray, and multiple black bolts securing the top and bottom components. In some embodiments, the outer part of the rigid module is transparent, opaque, or translucent. In some embodiments, the inner part of the rigid module has a cavity for housing various components such as a motor, electronic circuit, battery etc. According to some embodiments, the one or more guiding channels are connected to the bottom the rigid module. In some embodiments, the rigid module has a single unibody structure with no connecting subparts.

According to some embodiments, rivets 412 are manufactured separately from the rigid module 408 and the SCM component sheet 402. The rivets can be made of any suitable material such as a plastic, thermoplastic, metal, wood, fiberglass, aluminum, or combination thereof.

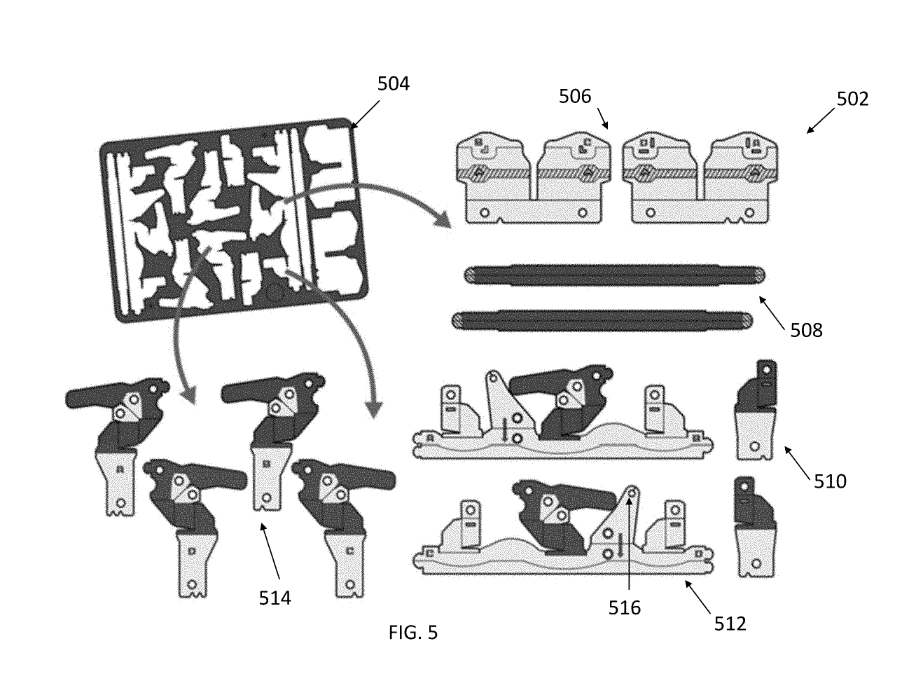

FIG. 5 illustrates SCM components 502 detached from the SCM component sheet 504. According to certain embodiments, components 506 are front and rear plates of a robot. They are configured to connect the leg portion of the robot. In some embodiments, one plate is mounted to the front part of a rigid module, and the other plate is mounted to the back part of the rigid module. Components 508 are stabilizing bars for aligning the components 506 once they are mounted to the rigid module. Components 510 are connecting parts for attaching the leg brackets 512 to the rigid module. Components 514 are the robot legs. Together, components 514 and leg brackets 512 form the feet portion of the robot according to certain embodiments. In some embodiments, the leg bracket 512 contains a connecting interface 516 with separable tabs. In some embodiments, once the leg bracket 512 is installed, the connecting interface 516 is down (same direction as the arrow) to make a connection with a motor output.

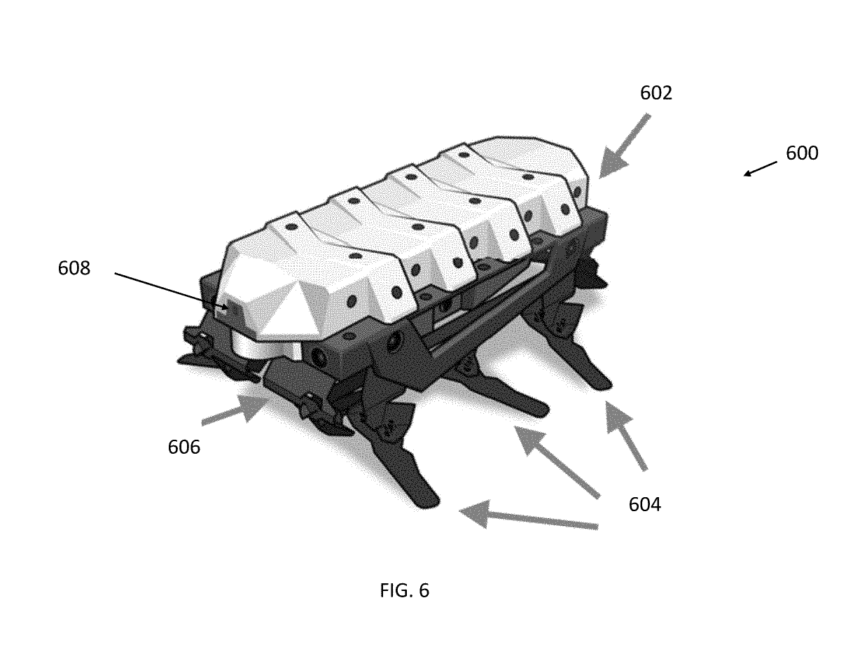

FIG. 6 illustrates an assembled robot 600 according to certain embodiments of the disclosure. The rigid module 602 is the body of the robot 600. A plurality of the flexible SCM components are connected to the rigid module 602 to form the lower body of the robot. In FIG. 6, SCM components 604 are three left legs of the robot 600. The frontal plate 606 provides additional connection points for components such as the scorpion's claws. The black plate, on the opposite side of the fontal plate 606, also provides additional attachment points for components such as a tail or pincer. The window 608 provides an opening for various devices such as a sensor, recorder, camera, light, or any other suitable device or combination of devices. In some embodiments, the top part of the rigid module 602 has additional connectors or sockets for attaching other objects. In some embodiments, the rigid module 602 is opaque or translucent to allow the penetration of light. In some embodiments, the left and right sides of the robot have more than three legs respectively. In some embodiments, each side has less than three legs. In some embodiments, the legs are replaced with other travel mechanisms such as wheels, fins, wings, or any other mechanisms or combination of mechanisms. These travel mechanisms may or may not be made from SCM technology.

In some embodiments, when the robot is mobilized, the legs move in a synchronized fashion to cause the robot to travel forward or backward. In some embodiments, the left-side legs and right-side legs move as two separate units. In some embodiments, the left set of legs and right set of legs move in an alternating fashion such that when the right set legs are rotating towards the ground the left set legs are rotating off the ground. Depending on the speed of the onboard motor, this alternating motion can occur many times per second to allow the robot to travel at a fast pace. According to some embodiments, one set of legs can move faster than the other set of legs and thus causes the robot to turn. According to certain embodiments, the robot mimics the traveling motion of a crawler insect such as a scorpion.

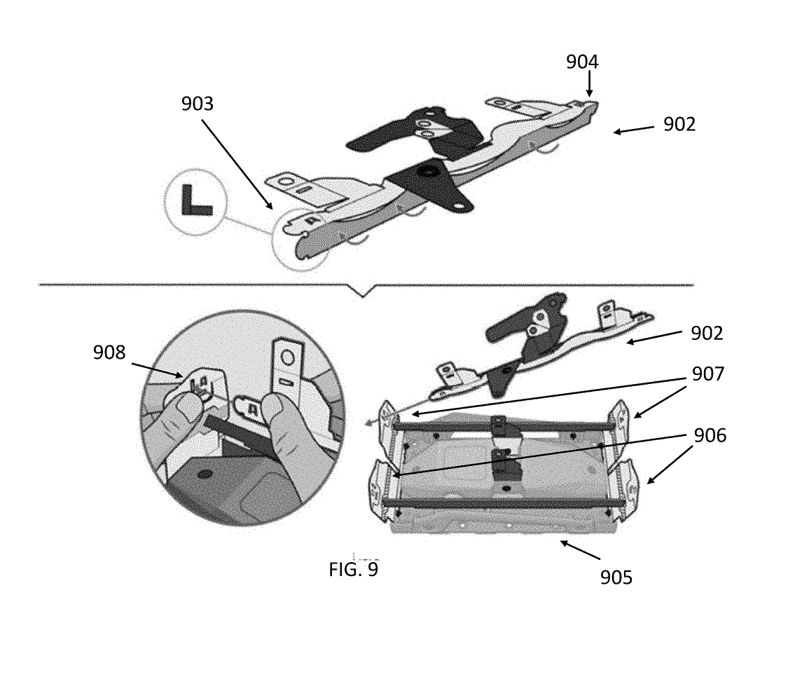

Although not visible in FIG. 6, in some embodiments, an internal component such as an onboard motor is housed in the rigid module 602. In some embodiment, the internal component is sandwiched between the SCM components and the rigid module 602. In some embodiments, the internal component is fully enclosed in the rigid module's cavity with only the output connectors exposed. FIG. 9 illustrates an exemplary view of such configuration. In some embodiments, the onboard motor is a servo motor configured to rotate the object connected. Other small motors or actuators may also be used. In some embodiments, the onboard motor is responsive to wireless commands. In some embodiments, the onboard motor's settings are programable.

The internal component can be any device capable of setting the robot in motion by moving the connected SCM components. The internal component can be a battery, actuator, or motor powered by electricity, fuel, or other suitable energy source such as light. In some embodiments, the internal component is a windup mechanism. In some embodiments, the movement of the robot is dictated by the design and configuration of the internal device. For example, if the robot is designed for underwater travel the internal device can be a motor configured to drive the propellers. If the robot is a helicopter robot, the internal component can be a motor configured to power the helicopter blades. In some embodiments, more than one motor component is placed inside the robot.

In some embodiments, the inside of the rigid module is compartmentalized to house various electronic devices. Besides the motor discussed above, in some embodiments the rigid module houses one or more circuit boards, processors, memories, wireless communicators, multi-axis accelerometers, multi-axis gyroscopes, infrared (IR) transmitters, various sensors such as IR, vibration, and optic sensors, lights such as LED lights and laser, onboard cameras, microphone, speakers, and any other suitable component or combination thereof. In some embodiments, one or more of these components work together to allow remote programing of the robot. In some embodiments, one or more of these components work together to allow wireless control of the robot. In some embodiments, a light source is placed inside an opaque or translucent rigid module such that the color change can be readily observed.

In some embodiments, the robot is configured to establish wireless connection with a controller via wireless transmission (for example, home RF or Wi-Fi). In some embodiments, the communication protocols include Bluetooth, Zigbee, IEEE 802.11, or other cellular standards or combination of standards. According to certain embodiments, the controller is a phone, computer, electronic tablet or other suitable device with a programmable user interface.

Referring back to FIG. 6, in some embodiments, the window 608 is a projecting outlet for various sensors and/or actuators. In some embodiments the window 608 can house an optical sensor to determine the robot's distance from an object to prevent collision. In some embodiments, the window 608 can house a video recording device to capture videos from the robot's viewpoint while the robot is in motion. In some embodiments, the window 608 can house a camera to capture pictures from the robot's viewpoint while the robot is in motion.

In some embodiments, the robotic 600 may include additional components, fewer components, or any other suitable combination of components that perform any suitable operation or combination of operations.

### Assembly System

The following paragraphs will discuss the assembly system in more detail, including various connecting mechanisms. Although the connecting mechanisms are described in a particular order, different assembly orders are within the scope of this invention. In some embodiments, a complete assembly requires all connecting mechanisms/steps described herein. In some embodiments, only one connecting mechanism/step described herein is required.

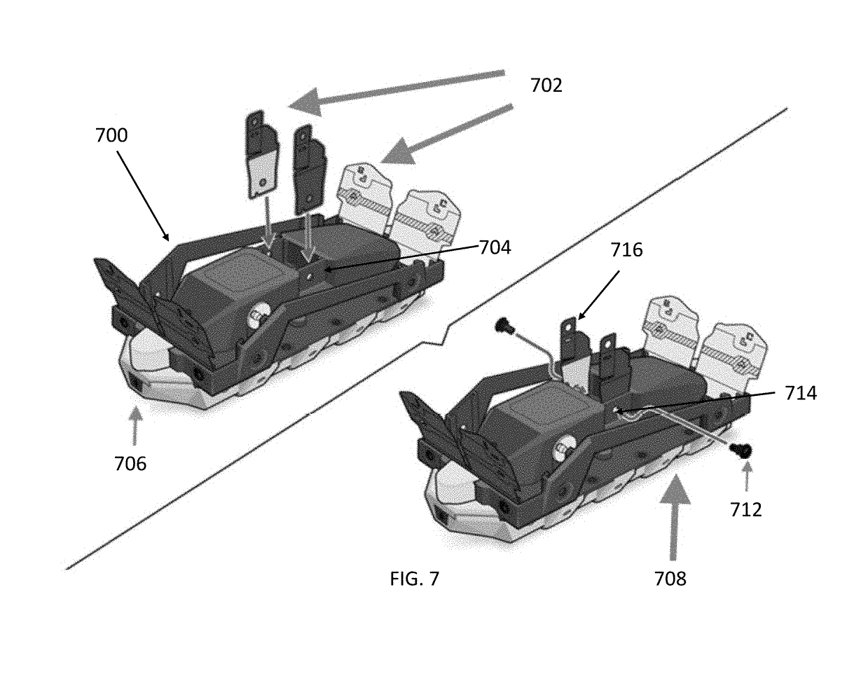

FIG. 7 illustrates sliding the SCM components 702 into the guiding channels 704 of the rigid module 706 of the robot 700. According to certain embodiments, robot 708 demonstrates the configuration after the SCM components are inserted into their respective channels. Only after the SCM components 716 are properly inserted, can rivets 712 punch through the securing holes 714 to hold the components in place. FIG. 7 demonstrates one assembly mechanism for avoiding misconnection. In some embodiments, the guiding channels 704 are component specific. That is, only the right component in the right orientation can be properly inserted into the guiding channel. This feature helps reduce assembly errors caused by misconnecting similar SCM components.

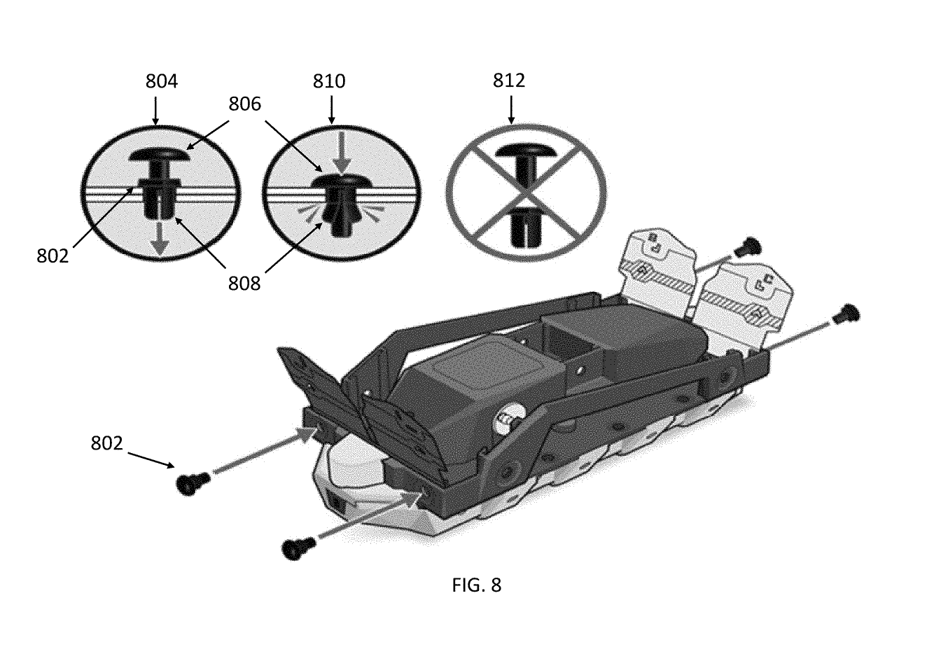

FIG. 8 illustrates a rivet securing mechanism according to certain embodiments of the disclosure. In view of FIG. 7, once the right SCM component is fully inserted into the guiding channel, one or more rivets 802 can be used to secure the SCM component in place. Steps 804 and 806 demonstrate how the rivet works according to certain embodiments of the disclosure. The rivet 802 is designed with a unibody push-and-lock mechanism. In Step 804, the rivet feet 808 is inserted into the hole formed by the guiding channel and the inserted SCM component. In this position, the rivet head 806 is still lifted, therefore, the rivet 802 can still be removed easily. Step 810 illustrates the locked-in position where the rivet head 806 is pushed through the hole and causes the rivet feet 808 to kick out. Once the rivet feet are kicked out, the SCM component is properly secured against the guiding channel. In some embodiments, a mechanical feedback (such as a clicked-in vibration or a clicked-in sound) is provided once the rivet feet are kicked out. In some embodiments, the rivets are used to secure one SCM component to another. As shown in 812, the rivet is not a two-part component. In some embodiments, the rivets provide a semi-permanent connection which can be removed without damaging the rivet. In some embodiments, the rivets provide a permanent connection which cannot be removed without destroying the rivet.

Rivets with a unibody push-and-lock mechanism provide certain advantages for the assembly process. First, this design reduces the amount of assembly components needed to be accounted for during an assembly process. Second, compared to the two-part fastening mechanisms (e.g., the one disclosed in 816), this design reduces the chance for missing parts. A missing sub part can lead to a frustrating assembly experience. Third, this rivet design is ideal for securing SCM components into a tight or unreachable back space. Once the rivet is pushed into the components, the component is secured. The assembler does not need to deal with aligning a separate component from the backside. It is especially useful in certain embodiments where the robot is designed for small children or assemblers with no robot building experience.

The unibody push-and-lock rivets described herein can be made of any appropriate materials, such as plastic, rubber, thermoplastic or fiberglass. While certain embodiments employ the unibody push and lock rivets, other fastening mechanisms could also be used. Other suitable fastening mechanisms include buckle tabs, snap clasps, screws, magnets, etc.

FIG. 9 illustrates using a combination of assembly indicators or markings to facilitate the assembly process according to certain embodiments. The leg bracket component 902 has a letter indicator “A” on one end 903 of the component and another indicator “B” on the other end 904 of the component. The end edges at 903 and 904 are folded into a 3D structure with gaped “L” shape insertion tabs. The rigid module 905 has left connecting hubs 906 and right connecting hubs 907, all with L shaped slots for inserting the insertion tabs. However, only the right connecting hubs 907 are labeled with indicators A and B. Hence, based on the orientation of the L shape insertion tabs and the matching letter indicators, the assembler would know that the right connecting hubs 907 are the correct insertion terminals. Step 908 illustrates a zoomed-in view of how the L shape insertion tabs fits into the L shape slots at terminal A of the right connecting hubs 907. Multiple SCM components with similar attachment interfaces can leave assemblers at risk of misconnection and/or lead to improper/incomplete connections. Using matching indicators would significantly reduce such risks. In some embodiments, matching indicators not only guide the assembler to the right connection site, but also ensure the components are connected in the right orientation.

In some embodiments, the matching indicators or markings can be of the same letters, numbers, colors, or symbols. In some embodiments, the matching indicators can be of a different or complementary letter, number, color, or symbol. For instance, a component with a “+” symbol may be connected to a component with a “−” symbol. Other comparable labeling schemes (for example, numbered parts or matching symbols) may also be employed. In some embodiments, multiple matching indicators are used to label each SCM component. In some embodiments, a matching rule can be used in conjunction with matching indicators.

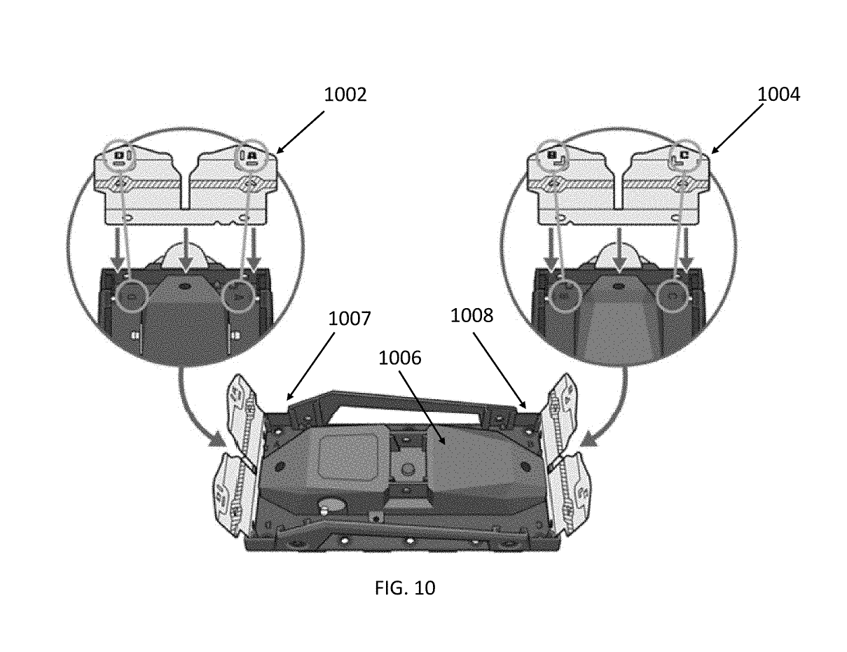

FIG. 10 illustrates using letter indicators to ensure that the frontal plate 1002 and the rear plate 1004 are connected to the correct terminals. According to certain embodiments, the frontal plate 1002 is labeled with letters A and D, and the rear plate is labeled with B and C. the rigid module 1006 is also labeled with corresponding letters A and D at its frontal terminal 1007, and with corresponding letters B and C at its rear side terminal 1008. In some embodiments the letters on the rigid module are placed in such a way that once the plates are attached, both matching letters can be observed from a top-down view in the same region.

Together, FIGS. 9 and 10 illustrate how connection indicators or markings are integrated into the whole assembly process according to certain embodiments. Components with the same letter are directed to the same regions to avoid confusions that may lead to misconnections. The labeling scheme could help assemblers with no robot building experience to build the robot correctly in the first try. In some embodiments, the labeling scheme substitutes the need for an instruction manual. Overall, the labeling scheme takes away the guess work in the assembly process and ensures that the right connections are made.

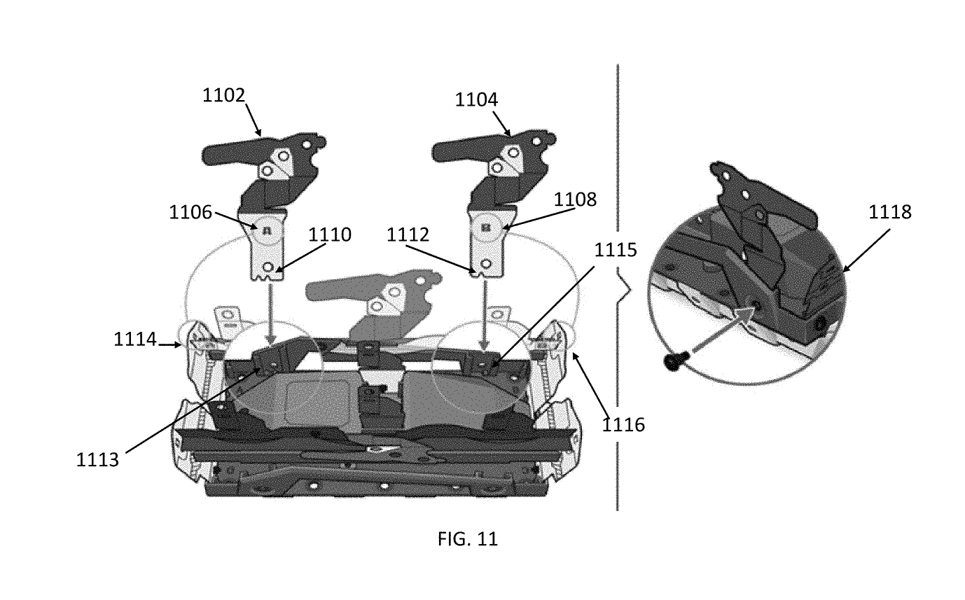

FIG. 11 illustrates how multiple assembly indicators and/or markings work together to ensure that the right connections are made in the first try. Beside the location labeling markings, according to some embodiments, the SCM components are designed with unique connecting interfaces such that only the right component can be properly connected. In FIG. 11, the leg component 1102 is labeled with letter indicator 1106 (“A”) that matches the indicators at the “A” region 1114. The same component is designed with a unique indentation pattern 1110 that complements the unique protrusion pattern at the bottom of the guiding channel 1113. Similarly, the leg component 1104 is labeled with another letter indicator 1108 (“B”) that matches the indicators at the “B” region 1116. The leg component 1104 is also designed with a unique indentation pattern 1112 that is different than the indentation 1110 of the component 1102. The unique indentation 1112 complements the unique protrusion pattern at the bottom of the guiding channel 1115. In some embodiments, the indentation pattern is in the receiving site while the protrusion pattern is on the components. In some embodiments, non-unique parts share the same indentation/protrusion pattern. In some embodiments, the indentation-protrusion only allow the correct component to connect in a particular orientation.

The indentation-protrusion system prevents similar parts from connecting to the wrong terminals. Even if the assembler overlooked the letter indicators and mistakenly inserted a component into the wrong terminal, the terminal would reject the connection. That is, the component would not be able to achieve a proper connection for the fastening component to push through. As shown in 1118, only a proper connection would allow a rivet to secure the SCM component. This added mechanism further reduces the chance of misconnection.

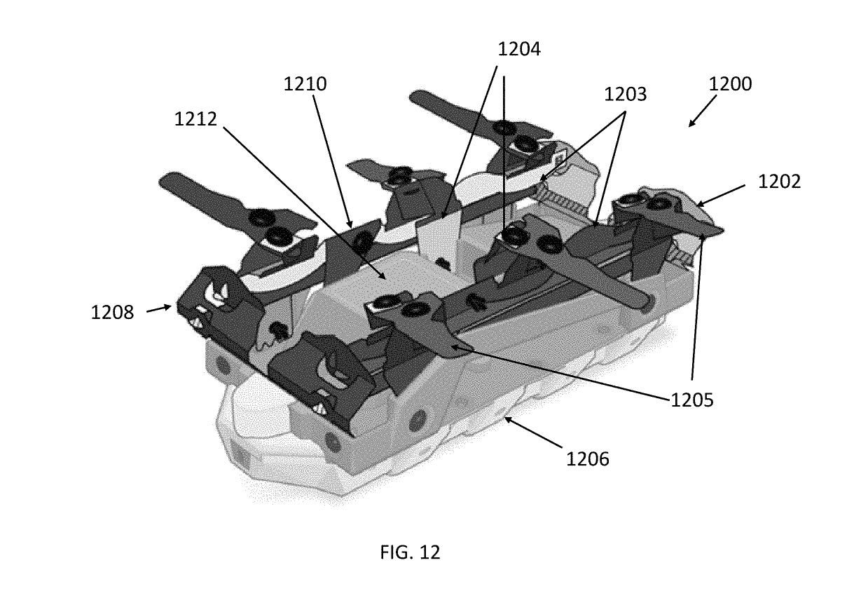

FIG. 12 illustrates a bottom view of an assembled robot 1200 according to certain embodiments. In some embodiments, the middle legs 1204 are attached via the assembly process disclosed in FIGS. 7 and 8. The frontal plate 1208 and rear plate 1202 are connected via the assembly process discussed in FIG. 10. The leg bracket components 1203 are connected using the assembly process discussed in FIG. 9. And the legs 1205 are attached using the assembly process discussed in FIG. 11. In addition, although the connection is not directly visible, FIG. 12 also illustrates the position where connector 1210 is connected to an internal component according to certain embodiments. In some embodiments, the housing 1212 of the rigid module 1206 contains a motor with motor outputs to actuate the leg components via connector 1210.

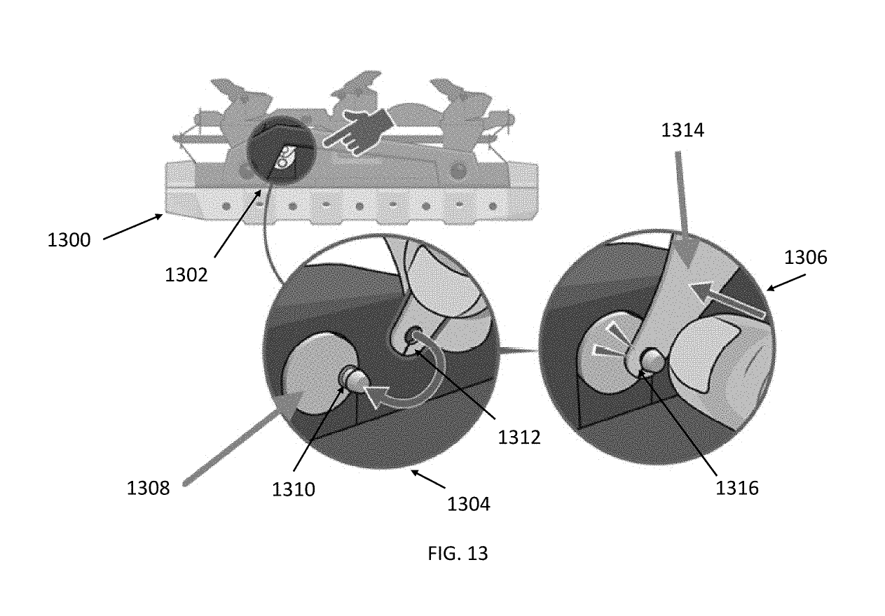

FIG. 13 illustrates the steps for securing a SCM component 1314 to an output of the internal component according to certain embodiments. In some embodiments, the internal component is an onboard motor (not shown) with the motor output arm 1310 attached to a rotary plate 1308. The onboard motor is housed close to the frontal portion 1302 of the robot 1300. Steps 1304 and 1306 illustrate the steps for connecting a SCM component to an internal component according to certain embodiments. Step 1304 shows a SCM component 1314 with the flexible tab connection interface 1312. The flexible table connection interface 1312 allows the SCM component 1314 to clamp on to the motor output arm 1310. The motor output arm 1310 has a neck portion that is skinnier than the head portion. To make the connection, the assembler only needs to push the connection interface 1312 into the motor output arm 1310 until the flexible tabs fully enclose the neck portion of the motor output arm 1316. In some embodiments, a feedback mechanism (e.g., a mechanical vibration or clicking sound) is provided to let the assembler know that the connection is complete. In some embodiments, other connection interface and mechanisms are employed. For example, an onboard motor could have one or more sockets designed to fit certain insertion object on a SCM component. In some embodiments, multiple SCM components are connected to the same motor output. In some embodiments, the motor output is connected to a chain of SCM components.

Referring back to FIG. 12, in some embodiments, the SCM component connecting to the motor output arm 1310 is the SCM connecting component 1210. In the connected state, the internal component can drive the leg bracket components 1203 in an alternating fashion. That is, when the left side legs are rotating away from the ground, the right side legs are rotating towards the ground. According to some embodiments, this motion causes the robot feet to shuffle forward and rearward. In some embodiments, each motor output is connected to just one leg component (instead of the whole leg bracket component). In such configuration, the robot would move based on the rotation of the connected leg components. The other legs would still provide support to the robot.

### Assembly Process

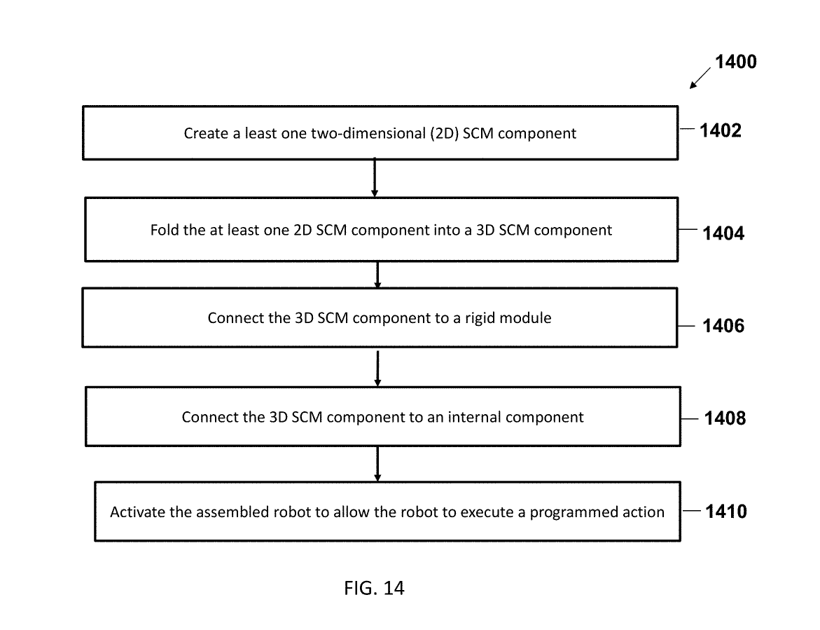

FIG. 14 is a flow chart illustrating a process 1400 for assembling a robot according to certain embodiments of the invention. The process 1400 is illustrated in connection with the robotic beetle 600 shown in FIG. 6. In some embodiments, the process 1400 can be modified by, for example, having steps rearranged, changed, added, and/or removed.

At step 1402, at least one two-dimensional (2D) SCM component is created. In some embodiments, the process for creating a 2D SCM component includes sandwiching an integral flexible layer between a first rigid layer and a second rigid layer to make an SCM board, removing a portion of the first and the second rigid layers on the SCM board to expose a portion of the integral flexible layer, and cutting the at least one SCM component from the SCM board. In some embodiments, more or less steps are involved in the process. According to some embodiments, the at least one SCM component has a first flat structural region connected to a second flat structural region via a bendable region composed of the exposed portion of the integral flexible layer similar to the configuration illustrated in FIG. 1. In some embodiments, the integral flexible layer has tear resistant greater than 10 N. The process 1400 then proceeds to step 1404.

At step 1404, the at least one 2D SCM component is folded into a three-dimensional configuration (becomes a 3D SCM component). In some embodiments, the 2D SCM component is folded along the bendable region. In some embodiments, the folding process includes slightly bending or tilting the at least one 2D SCM component so that when a flat structural region is in full contact with a flat surface, the other flat structural surface does not contact the flat surface. In some embodiments, once the SCM component is folded, it stays in the folded configuration (e.g., the bendable region would stay bent). The process 1400 then proceeds to step 1406.

At step 1406, the 3D SCM component is connected to a rigid module by a connection terminal on the rigid module. In some embodiments, the 3D SCM component is indirectly connected to the rigid module via another object. In some embodiments, the connection terminal is a receptacle, adapter, link, coupling, joint, socket, channel, or a combination thereof. Various connection mechanisms may be implemented; for example, slide-and-click latches, pins, grooves, notches, rotary engagement latches, click-and-lock tabs, or a combination thereof. In some embodiments, step 1406 includes an additional securing step after the connection is made. The securing step may involve fastening the connected 3D SCM component with at least a rivet, nail, screw, link, buckle, or a combination thereof.

According to some embodiments, at least one connection is made according to an assembly indicator. In some embodiments, no assembly indicator is involved. In some embodiments, components with similar site indicators are connected near one another. In some embodiments, multiple assembly indicators work together to ensure that only the correct connections are made. In some embodiments, wrong connections would prevent the assembler from properly securing the component. The process 1400 then proceeds to step 1408.

At step 1408, the at least one 3D SCM component is connected to an internal component housed in the rigid module. In some embodiments, the internal component is partially enclosed by the rigid module. According to some embodiments, the internal component is a device configured to locomotive capability to the robot; for example, a battery, actuator, motor, wind-up mechanism, or a combination therefore. In some embodiments, the internal component has more or less than two output connectors. In some embodiments, the connection is made by pushing the pole-clamping interface of the at least one 3D SCM component onto an output connector. See for example FIG. 13. In some embodiments, other interface and connecting mechanisms are used. The process 1400 then proceeds to step 1410.

At step 1410, the robot is ready to be activated. In some embodiments, the robot is activated to allow the robot to execute a programmed action such as flashing lights, spin, run, vibrate, dance, battle, record images or sounds, make noise, or a combination thereof. The robot can be activated via various methods. In some embodiments, the robot is activated by an on and off switch on the robot. In some embodiments, the robot is activated by a wireless signal. In some embodiments, the robot is activated by connecting to a computer. In some embodiment, the activation step involves programing the robot. In some embodiments, the robot can self-program once it is connected to a network. In some embodiments, the user can remotely program the robot via a user device. In some embodiments, once the robot is activated, the user can control the direction the robot travels.

While the description may refer to certain embodiments as a “robotic toy,” “toy robot,” “robot toy,” “robot,” “toy,” etc. These terms are merely exemplary ways to refer to certain embodiments of the present invention. These terms do not limit the present invention to a particular use or category of use. Moreover, although certain embodiments of the present invention are described according to a robot that looks like an insect, it is understood that other designs are also within the scope of the invention.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A robot with flexible mechanics and locomotive capability, comprising:
a) at least one Smart Composite Microstructure (SCM) component with flexible mechanics, the at least one SCM component comprising:
a first flat structural region that includes a first portion of two rigid structural layers that sandwich a first portion of an integral flexible layer in between;
a second flat structural region that includes a second portion of the two rigid structural layers that sandwich a second portion of the integral flexible layer in between; and
a bendable joint region that includes a third portion of the integral flexible layer and connects the first flat structural region and the second flat structural region;
b) a rigid module attached to the at least one SCM component; and
c) at least one internal component that is at least partially enclosed by the rigid module, wherein the at least one internal component provides locomotive capabilities to the robot.

2. The robot of claim 1, wherein the robot is at least one of a toy robot, biomimetic toy, crawler robot, remote-controlled toy, or autonomous robot.

3. The robot of claim 1, wherein:
a top portion of the robot comprises the rigid module; and
a bottom portion of the robot comprises the at least one SCM component.

4. The robot of claim 1, wherein the rigid module comprises at least one of a metal, plastic, wood, aluminum, steel, or copper.

5. The robot of claim 1, wherein the at least one internal component is at least one of an electronic device, motor, or battery.

6. The robot of claim 1, wherein the at least one SCM component is secured to the rigid module using at least a rivet, plastic rivet, thermoplastic rivet, metal rivet, aluminum rivet, buckle tab, snap clasp, or screw.

7. The robot of claim 1, wherein the rigid module has a connection terminal uniquely configured to connect the at least one SCM component.

8. The robot of claim 1, wherein the rigid module includes at least one channel to guide the at least one SCM component into a fixed position.

9. The robot of claim 1, wherein the rigid module includes an indentation pattern that complements a protrusion pattern on the at least one SCM component.

10. The robot of claim 1, wherein the rigid module includes a protrusion pattern that complements an indentation pattern on the at least one SCM component.

11. The robot of claim 1, wherein:
the rigid module includes a first hole;
the at least one SCM component includes a second hole that matches the first hole; and
the rigid module and the at least one SCM component are secured by a rivet inserted through the first hole and the second hole.

12. The robot of claim 1, wherein:
the at least one SCM component include a first marking; and
the rigid module includes a second marking that corresponds to the first marking.

13. The robot of claim 12, wherein the first marking and the second marking is a letter, number, or symbol.

14. The robot of claim 1, wherein:
the at least one internal component comprises a motor with a motor output connector; and
the at least one SCM component is connected to the motor via the motor output connector.

15. The robot of claim 14, wherein the at least one SCM component attached to the motor output connector is coupled to another component that is not attached to the motor output connector.

16. The robot of claim 1, wherein the integral flexible layer comprising a flexible material having a tear strength greater than 10 N.

17. A method for assembling a robot with flexible mechanics and locomotive capability, comprising:
creating at least one SCM component by sandwiching an integral flexible layer between a first rigid layer and a second rigid layer to make an SCM board, removing a portion of the first and the second rigid layers on the SCM board to expose a portion of the integral flexible layer, and cutting the at least one SCM component from the SCM board, wherein the at least one SCM component has a first flat structural region connected to a second flat structural region via a bendable region composed of the exposed portion of the integral flexible layer;
folding the at least one SCM component into a three-dimensional configuration;
connecting the folded at least one SCM component with at least one connection terminal on a rigid module based on an assembly indicator;
connecting the folded at least one SCM component to at least one internal component that is at least partially enclosed by the rigid module, wherein the at least one internal component provides locomotive capabilities to the robot; and
activating the robot to allow the robot to execute a programmed action.
